(19) United States
(12) Patent Application Publication
(10) Pub. No.: US 2004/0231834 A1
(43) Pub. Date: Nov. 25, 2004

(54) Vehicle air conditioner

(76) Inventors: Kazuji Shibata, Kariya-city (JP); Yoshio Yoshida, Handa-city (JP)

Correspondence Address: HARNESS, DICKEY & PIERCE, P.L.C., P.O. BOX 828, BLOOMFIELD HILLS, MI, 48303, US

(21) Appl. No.: 10/837,996

(22) Filed: May 3, 2004

(30) Foreign Application Priority Data
May 7, 2003 (JP) 2003-129170

(51) Int. Cl. B60H 3/00; B61D 27/00; B60H 1/00

(52) U.S. Cl. 165/204; 165/202; 165/42

(57) ABSTRACT

In a vehicle air conditioner, a defroster opening is provided at an upper side of a middle portion between an evaporator and a heater core arranged adjacently. A defroster door for opening and closing the defroster opening is a butterfly door having a door body portion and a rotation shaft. The defroster opening can be partitioned by a plate surface of the door body portion into a first communication passage at a side of the evaporator and a second communication passage at a side opposite to the evaporator. In the air conditioner, a guide member for restricting an air flow in the first communication passage is provided at least one of the door body portion and an air conditioning case. Thus, it can restrict a windshield from being fogged due to evaporation of condensed water by hot air of the heater core when a blower is stopped.

### CROSS REFERENCE TO RELATED APPLICATION

This application is based on Japanese Patent Application No. 2003-129170 filed on May 7, 2003, the disclosure of which is incorporated herein by reference.

### FIELD OF THE INVENTION

The present invention relates to a vehicle air conditioner which can restrict a windshield from being fogged by high-humidity air generated due to evaporation of condensed water of a cooling heat exchanger when an air conditioning operation is stopped.

### BACKGROUND OF THE INVENTION

Because an air conditioning unit of a vehicle air conditioner is generally mounted in a small space of a dashboard on a front side in a passenger compartment, it is required to reduce the size of the air conditioning unit. Therefore, in a vehicle air conditioner described in JP-A-11-235916 (corresponding to U.S. Pat. No. 6,244,335), an evaporator and a heater core are adjacently arranged at a small interval in a vehicle front-rear direction within an air conditioning case.

For example, in an air conditioning unit shown in FIG. 12, an evaporator 12 and a heater core 13 are adjacently arranged by a small space equal to or lower than 150 mm in a vehicle front-rear direction, and an air mixing door 16 is arranged between the evaporator 12 and the heater core 13 to adjust a temperature of air to be blown into a passenger compartment. Further, a defroster door 22′ for opening and closing a defroster opening 21 is a plate door rotatable around a rotation shaft 22b′, and a face/foot switching door 28′ is also a plate door rotatable around a rotation shaft 28′.

FIG. 12 shows a foot/defroster mode where the defroster door 22′ is operated to a middle position to open the defroster opening 21 and a communication path 34. A face opening 26 and a foot opening 27 are provided downstream of the communication passage 34. Further, the face/foot switching door 28′ is operated to close the face opening 26 and to open the foot opening 27. In the foot/defroster mode, warm air temperature-conditioned by the air mixing door 16 is blown toward an inner surface of a vehicle windshield from the defroster opening while being blowing toward the foot area of a passenger in the passenger compartment from a foot air outlet 31 through the foot opening 27 and a foot air passage 30.

Furthermore, even when the vehicle air conditioner including a blower is stopped in accordance with a stop of a vehicle engine, hot water in an inner part of the heater core 13 is maintained at a high-temperature state briefly. Therefore, condensed water adhering on the evaporator 12 is evaporated by heat from the heater core 13. In addition, as shown in FIG. 12, because the defroster opening 21 is opened at an upper portion of a middle part between the evaporator 12 and the heater core 13, high-humidity air due to the evaporation of condensed water can be readily introduced into the defroster opening 21. As a result, the windshield is readily fogged due to the high-humidity air when the vehicle air conditioner is stopped in the foot/defroster mode.

### SUMMARY OF THE INVENTION

In view of the above-described problems, it is an object of the present invention to provide a vehicle air conditioner which can restrict condensed water on a cooling heat exchanger from being evaporated due to heat of a heating heat exchanger when a blower is stopped, and it can restrict a windshield from being fogged.

According to the present invention, a vehicle air conditioner includes an air conditioning case for defining an air passage through which air flows into the passenger compartment, a cooling heat exchanger for cooling air, a heating heat exchanger for heating air disposed in the air conditioning case downstream from the cooling heat exchanger to be separated from the cooling heat exchanger by a space smaller than a predetermined distance, a defroster door for opening and closing the defroster opening, and a guide member disposed to restrict an air flow from a downstream side of the cooling heat exchanger into the defroster opening. The defroster door is constructed with a butterfly door having a plate-shaped door body portion and a rotation shaft arranged at a center portion of the door body portion. Further, the defroster opening is provided at an upper side of the cooling heat exchanger and the heating heat exchanger, and is partitioned into a first communication passage on a side of the cooling heat exchanger and a second communication passage on a side opposite to the cooling heat exchanger by a plate surface of the door body portion when the defroster opening is opened by the defroster door. In addition, the rotation shaft of the defroster door is rotatably held in the case, and the guide member is provided in the first communication passage.

Because the heating heat exchanger and the cooling heat exchanger are arranged adjacently to have the space smaller than the predetermined distance, condensed water on the evaporator may be readily evaporated by heat from the heating heat exchanger when the air conditioned is stopped. However, according to the vehicle air conditioner of the present invention, the guide member can restricts high-humidity air generated due to the evaporation of condensed water from flowing into the defroster opening through the first communication passage, and it can prevent the windshield from being fogged when a blower of the vehicle air conditioner is stopped.

Preferably, the door body portion of the defroster door has an upstream end portion and a downstream end portion in a flow direction of air passing through the defroster opening, and the guide member is provided to protrude from the upstream end portion of the door body portion into the first communication passage. For example, the guide member is a rigid plate molded integrally with the door body portion. Alternatively, the guide member is an elastic plate bonded to the door body portion. In this case, when the blower is operated, the guide member is pressed to an upper side by an air pressure, and is elastically deformed to increase a passage sectional area of the first communication passage. In contrast, when the blower is stopped, the guide member is elastically deformed by its weight to reduce the passage sectional area of the first communication passage. Therefore, when the blower is stopped, the air amount flowing through the first communication passage can be effectively restricted.

Alternatively, the guide member is a rib protruding toward the upstream end portion of the door body portion from the air conditioning case at a position where the first communication passage is formed. In this case, the guide member is provided in such a manner that a clearance between the guide member and the upstream end portion of the door body portion is equal to or smaller than 3 mm when the defroster door is operated to an operation position of a foot/defroster mode where both the defroster opening and the foot opening are opened. Therefore, the guide member reduces the air amount flowing through the first communication passage in the foot/defroster mode, so that it can restrict the windshield from being fogged when the vehicle air conditioner is stopped.

### BRIEF DESCRIPTION OF THE DRAWINGS

Other objects, features and advantages of the present invention will become more apparent from the following detailed description made with reference to the accompanying drawings, in which:

FIG. 1 is a schematic sectional view showing an air conditioning unit of a vehicle air conditioner in a foot/defroster (FOOT/DEF) mode according to a first embodiment of the present invention;

FIG. 2 is a schematic sectional view showing the air conditioning unit in a face mode according to the first embodiment;

FIG. 3 is a schematic sectional view showing the air conditioning unit in a bi-level mode according to the first embodiment;

FIG. 4 is a schematic sectional view showing the air conditioning unit in a foot mode according to the first embodiment;

FIG. 5 is a schematic sectional view showing the air conditioning unit in a defroster mode according to the first embodiment;

FIG. 6 is a schematic sectional view showing a blower unit according to the first embodiment;

FIG. 7 is a perspective view showing a defroster door according to the first embodiment;

FIG. 8 is a schematic sectional view showing an air conditioning unit of a vehicle air conditioner in a foot/defroster mode according to a second embodiment of the present invention;

FIG. 9A is an enlarged sectional view showing a main part of the air conditioning unit in FIG. 8 when operation of the air conditioner is stopped in a foot/defroster mode, and FIG. 9B is an enlarged sectional view showing the main part of the air conditioning unit in FIG. 8 when the air conditioner operates, according to the second embodiment;

FIG. 10 is a schematic sectional view showing an air conditioning unit of a vehicle air conditioner in a foot/defroster mode according to a third embodiment of the present invention;

FIG. 11A is an enlarged sectional view showing an example of a main part of the air conditioning unit in FIG. 10, and FIGS. 11B and 11C are enlarged sectional views showing the other examples of the third embodiment; and

FIG. 12 is a schematic sectional view showing an air conditioning unit during a foot/defroster mode in a related art.

### DETAILED DESCRIPTION OF THE PREFERRED EMBODIMENTS

### First Embodiment

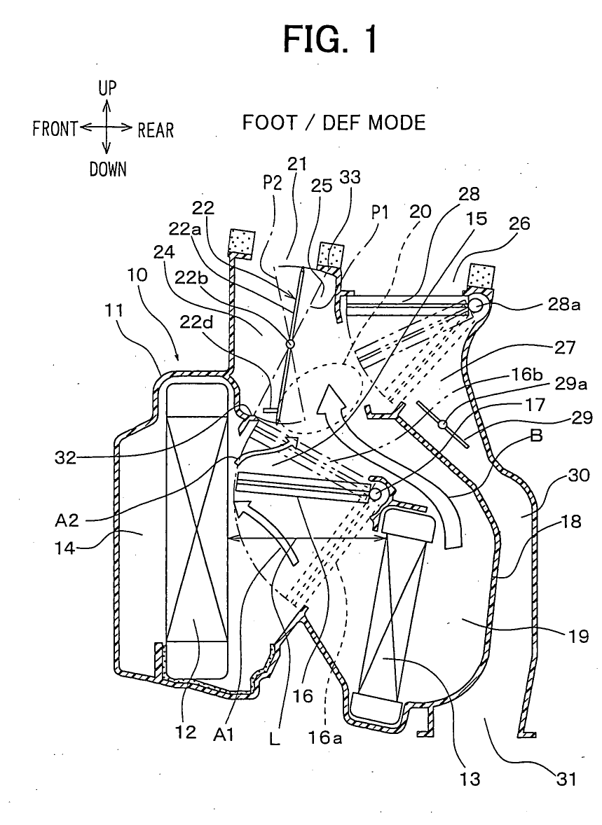

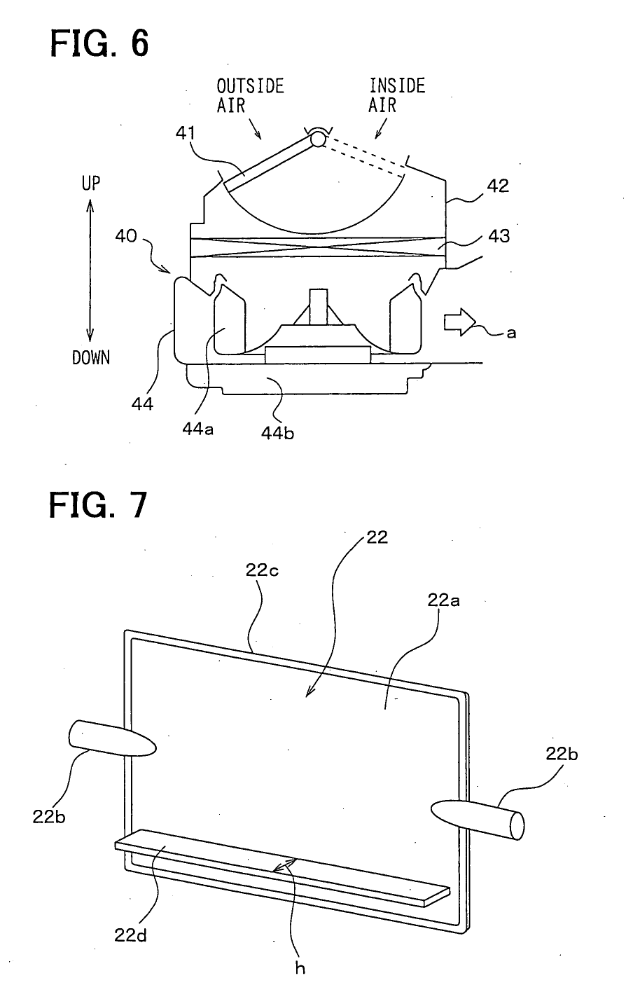

The first embodiment of the present invention will be now described with reference to FIGS. 1-7. An interior unit of a vehicle air conditioner includes an air conditioning unit 10 shown in FIGS. 1-5, and a blower unit 40 shown in FIG. 6.

The air conditioning unit 10 is disposed inside a dashboard within a passenger compartment at an approximate center portion in a vehicle right-left direction to be arranged as shown in FIGS. 1-5 in a vehicle front-rear direction and in a vehicle up-down direction. In contrast, the blower unit 40 is disposed inside the dashboard within the passenger compartment to be offset from the center portion in the vehicle right-left direction.

The blower unit 40 is constructed with an inside/outside air switching box 42 and a blower 44, as shown in FIG. 6. The inside/outside air switching box 42 includes an inside air introduction port for introducing inside air (i.e., air inside the passenger compartment), an outside air introduction port for introducing outside air (i.e., air outside the passenger compartment), and an inside/outside air switching door 41 for opening and closing the inside air introduction port and the outside air introduction port. A filter 43 for filtering air is disposed so that air introduced from the inside/outside air switching box 42 is drawn into the blower 44 after passing through the filter 43. The blower 44 includes a centrifugal fan 44a for blowing air into the air conditioning unit 10, and an electrical motor 44b for driving and operating the centrifugal fan 44a.

The air conditioning unit 10 includes a single air conditioning case 11 for defining an air passage through which air flows into the passenger compartment. An evaporator 12 used as a cooling heat exchanger and a heater core 13 used as a heating heat exchanger are integrally accommodated in the single air conditioning case 11. The air conditioning case 11 is divided into plural division case parts made of resin, and the plural division case parts are integrally fastened by using a fasten member such as metal spring clips and screws. An air inlet space 14 is formed at a most front side position in the air conditioning case 11.

Air is blown from an air blowing port of the blower unit 40 as shown by the arrow “a” in FIG. 6, and flows into the air inlet space 14 in the air conditioning case 11. Then, air flowing into the air inlet space 14 flows toward a vehicle rear side.

The evaporator 12 is disposed in the air conditioning case 11 at a position directly downstream from the air inlet space 14. The evaporator 12 is thin in the vehicle front-rear direction, and extends vertically to across the air passage in the air conditioning case 11. In the evaporator 12, low-pressure refrigerant of a refrigerant cycle is evaporated by absorbing heat from air passing through the evaporator 12, so that air passing through the evaporator 12 is cooled.

The heater core 13 is disposed downstream of the evaporator 12 to heat air after being cooled in the evaporator 12. High-temperature hot water (engine cooling water) flows into the heater core 13 so that air passing through the heater core 13 is heated by using the hot water as a heating source. The heater core 13 is adjacently arranged downstream of the evaporator 12 to have a predetermined distance L between the evaporator 12 and the heater core 13.

The heater core 13 is disposed at a lower side in the air conditioning case 11 to be slightly tilted to a vehicle rear side from the vertical direction (i.e., the vehicle up-down direction). In this embodiment, the predetermined distance L is set at a small value (e.g., not larger than 150 mm) in order to reduce the dimension of the air conditioning unit 10 in the vehicle front-rear direction. Here, the distance L is a distance at a position where a heat-exchanging core portion of the evaporator 12 is separated in maximum from a heat-exchanging core portion of the heater core 13.

The heater core 13 is disposed in the air conditioning case 11 to form a cool air bypass passage 15 in the air conditioning case 11 at an upper side of the heater core 13. Air bypasses the heater core 13 through the cool air bypass passage 15. An air mixing door 16 is disposed between the evaporator 12 and the heater core 13 so as to adjust a flow ratio between an air amount passing through the heater core 13 and an air amount passing through the bypass passage 15. By adjusting the flow ratio between the air amount passing through the heater core 13 and the air amount bypassing the heater core 13, the temperature of air to be blown into the passenger compartment can be adjusted.

The air mixing door 16 is constructed with a plate door that is rotatable around a rotation shaft 17 extending in the vehicle right-left direction. The air mixing door 16 is a temperature adjustment means for adjusting the temperature of air blown into the passenger compartment. When the air mixing door 16 is rotated to a maximum cooling position 16a, a maximum cooling operation is set so that an inlet portion of the heater core 13 is fully closed and the cool air bypass passage 15 is fully opened. When the air mixing door 16 is rotated to a maximum heating position 16b, a maximum heating operation is set so that an inlet portion of the heater core 13 is fully opened and the cool air bypass passage 15 is fully closed.

The rotation shaft 17 is positioned around an upper end of the heater core 13 to be rotatably supported in right and left side-wall portions of the air conditioning case 11. One end portion of the rotation shaft 17 protrudes to an outside portion of the air conditioning case 11, and is connected to a temperature adjustment operation mechanism through a link mechanism so that the rotation position of the air mixing door 16 is adjusted. The temperature adjustment operation mechanism can be constructed with an actuator using a servomotor or can be constructed with a manual operation mechanism.

A wall portion 18 extending in the up-down direction is integrally formed with the air-conditioning case 11 at a downstream position of the heater core 13 to be separated from the heater core 13 by a predetermined distance. A warm air passage 19 extending from a position (air outlet) immediately after the heater core 13 to an upper side is formed by the wall portion 19. An upper side of the warm air passage 19 is joined with the cool air bypass passage 15 at an upper portion of the heater core 13. Warm air from the warm air passage 19 and cool air from the cool air bypass passage 15 are mixed in an air mixing portion 20 (join portion), so that conditioned air having a desired temperature can be obtained.

The evaporator 12 and the heater core 13 are separated from each other in the vehicle front-rear direction by a predetermined space, and a defroster opening 21 is arranged at an upper side portion of the predetermined space between the evaporator 12 and the heater core 13. Because the defroster opening 21 is positioned above the cool air bypass passage 15 and the air mixing portion 20, air from the cool air bypass passage 15 and the air mixing portion 20 flows into the defroster opening 21. The defroster opening 21 is connected with a defroster air outlet through a defroster duct so that conditioned air is blown toward an inner surface of a windshield of the vehicle from the defroster air outlet.

The defroster opening 21 is opened and closed by a defroster door 22. The defroster door 22 is constructed with a butterfly door, which includes a door body portion 22a and rotation shafts 22b as shown in FIG. 7. The butterfly door 22a has a rectangular plate shape with long sides and short sides, and the rotation shafts 22b are formed integrally with the butterfly door 22a at center portions of the door body portion 22a in a door width direction (door short-side direction) to extend in a door longitudinal direction (door long-side direction). As shown in FIG. 7, the rotation shafts 22b protrude from right and left two end sides (short sides) of the door body portion 22a. The door body portion 22a and the rotation shaft 22b of the defroster door 22 are molded integrally by using resin such as polypropylene to construct a door rigid portion.

As shown in FIG. 7, an elastic seal portion 22c is made of a rubber elastic material such as a thermoplastic elastomer, and is formed on the rectangular peripheral end portion of the door body portion 22a. When the elastic seal portion 22c is constructed of the thermoplastic elastomer, the elastic seal portion 22c can be integrally molded with the outer peripheral end portion of the door body portion 22a while the door body portion 22a and the rotation shaft 22b are resin-molded. The elastic seal portion 22c has a thin plate shape in a cross section.

The defroster door 22 is disposed at a lower side position of the defroster opening 21 such that the rotation shafts 22b are directed to the vehicle right and left directions and a plate surface of the door body portion 22a extends approximately in the vehicle up-down direction. Therefore, the lower end portion of the door body portion is used as an upstream end portion of the door body portion 22a, and the upper end portion of the door body portion is used as a downstream end portion of the door body portion 22a. The right and left rotation shafts 22b are rotatably supported in right and left side-wall portions of the air conditioning case 11.

A guide member 22d is molded integrally with the door body portion 22a to protrude by a predetermined height dimension from the door body portion 22a toward the evaporator 12 (vehicle front side) at a position proximate to the lower end portion (upstream end portion) of the door body portion 22a. As shown in FIGS. 1 and 7, the guide member 22d is a rigid plate, and extends in parallel with the upstream end portion of the door body portion 22a.

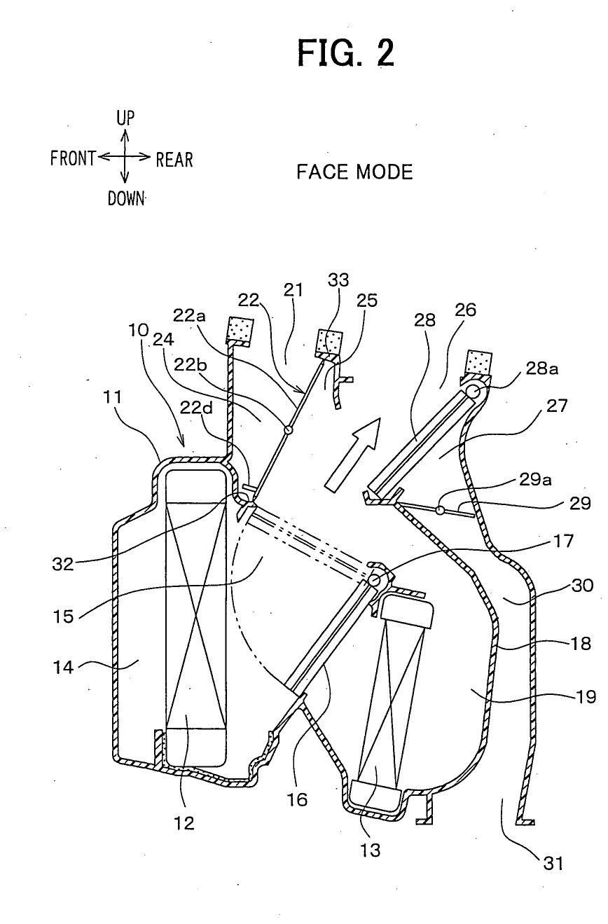

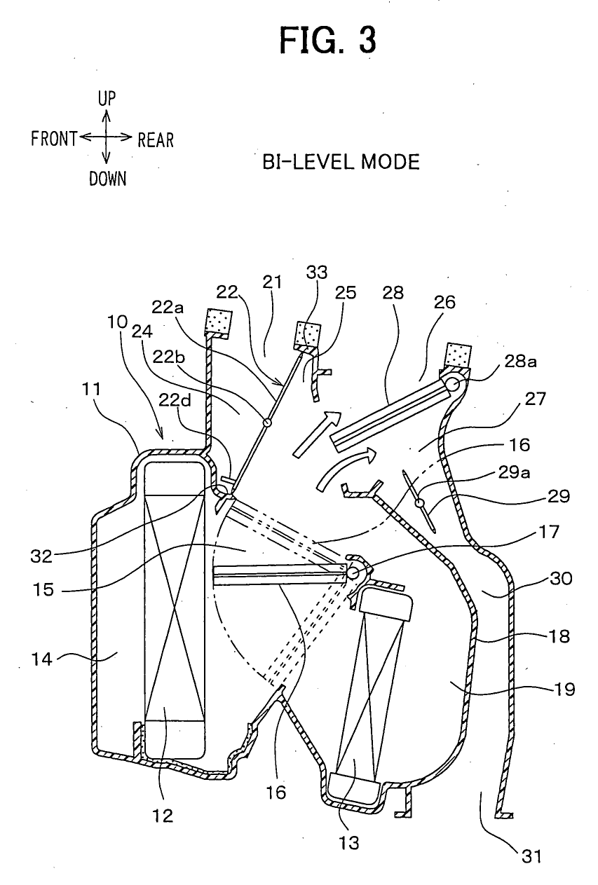

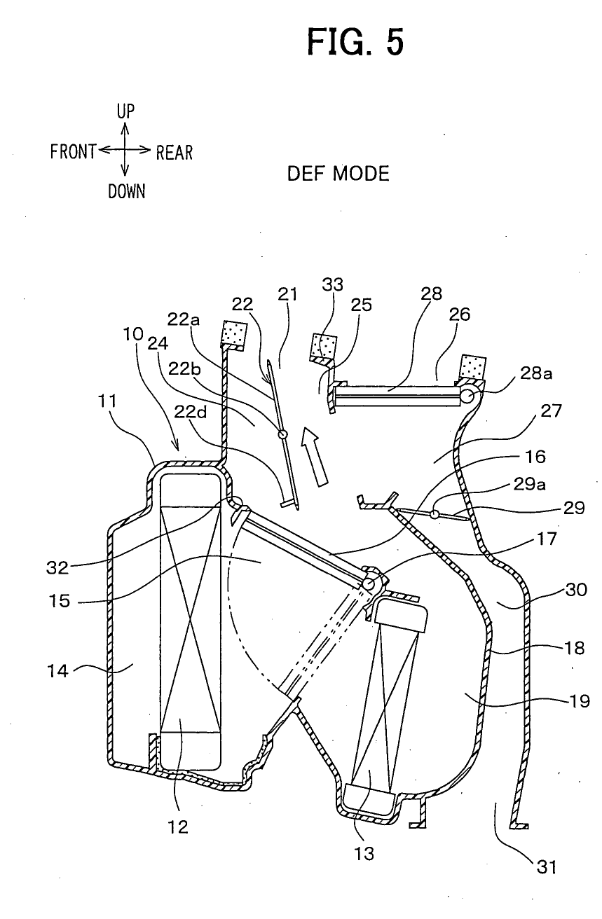

The defroster door 22 is disposed to be rotatable between a first position P1 and a second position P2. When the defroster door 22 is rotated to the first position P1, the defroster door 22 fully closes an inlet path of the defroster opening 21. For example, in the face mode (FIG. 2) and the bi-level mode (FIG. 3), the defroster door 22 fully closes defroster opening 21. In contrast, when the defroster door 22 is rotated to the second position P2 in FIG. 1, the defroster door 22 fully opens the inlet path of the defroster opening 21. When the defroster mode is set as shown in FIG. 5, the defroster door 22 fully opens the inlet path of the defroster opening 21.

When the defroster opening 21 is opened, the inlet path of the defroster opening 21 is partitioned by the plate surface of the door body portion 22a of the rotary door 22 into first and second communication passages 24, 25 at front and rear sides of the plate surface of the door body portion 22a. Therefore, the defroster opening 21 can communicate with a downstream side of the evaporator 12 and a downstream side of the heater core 13 through the first and second communication passages 24, 25, respectively.

The first communication passage 24 is closer to the evaporator 12 as compared with the second communication passage 25, among the both the first and second communication passages 24 and 25. That is, the first communication passage 24 at the vehicle front side is a communication passage at a side of the evaporator 12.

A face opening 26 is opened on the upper surface of the air conditioning case 11 at a vehicle rear side position from the face opening 26. Furthermore, a foot opening 27 is provided at a lower side position of the face opening 26. The face opening 26 and the foot opening 27 are opened and closed by the face door 28 and the foot door 29. The face door 28 and the foot door 29 are plate doors rotatable around rotation shafts 28a, 29a, respectively.

In this embodiment, the face door 28 is a plate door having a rotation shaft 28a at a door one end, and the foot door 29 is a butterfly door having a rotation shaft 29a at a center portion of a plate door. However, the face door 28 and the foot door 29 can be constructed with the other type plate doors. For example, the foot door 29 is a plate door having a rotation shaft at a door one end, and the face door 28 is a butterfly door having a rotation shaft at a center portion of a plate door member.

Conditioned air from the air mixing portion 20 can be introduced into the face opening 26 and the foot opening 27. The face opening 26 is connected to a face air outlet at an upper side of the dashboard through a face duct, so that conditioned air can be blown toward the upper body of a passenger in the passenger compartment from the face air outlet. Further, the foot opening 27 communicates with foot air outlets 31 opened at right and left end portions on the vehicle rear side of the air conditioning case 11, through a foot air passage 30, so that conditioned air can be blown toward the foot areas of the passenger in the passenger compartment from the foot air outlets.

The rotation shafts 22b of the defroster door 22, the rotation shaft 28a of the face door 28 and the rotation shaft 29 of the foot door 29 are rotatably supported in the right and left side wall portions of the air conditioning case 11. One end portions of the rotation shafts 22b, 28a, 29a protrude to an outside of the air conditioning case 11, and are connected to an air-outlet mode operation mechanism through a link mechanism.

The defroster door 22, the face door 28 and the foot door 29 are operatively linked with each other through the air-outlet mode operation mechanism.

A rib 32 is provided in the air conditioning case 11 at a vehicle rear side position of an upper end portion of the evaporator 12 to protrude into the first communication passage 24 at the side of the evaporator 12. In this embodiment, the rib 32 is used as a seal surface onto which a top end portion of the air mixing portion 16 and the lower end portion (upstream end portion) of the seal portion 22c of the defroster door 22 are pressed.

Further, a rib 33, onto which the upper end portion of the seal portion 22c of the defroster door 22 is pressed, is molded integrally with the air conditioning case 11.

Next, operation of the vehicle air conditioner according to the first embodiment will be now described.

(1) Face Mode

The face mode is generally set in a cooling operation of the passenger compartment in summer. When the face mode is set, the defroster door 22, the face door 28 and the foot door 29 are operated, respectively, at the positions shown in FIG. 2. That is, in the face mode, the defroster door 22 is operated most clockwise to the first position P1 in FIG. 1. At this time, the seal portion 22c of the defroster door 22 press-contacts the ribs 32, 33, and both the first and second communication passages 24, 25 at the inlet side of the defroster opening 21 are closed, so that the defroster opening 21 is fully closed. Further, the face door 28 is operated to fully open the face opening 26 and to fully close the foot opening 27, and the foot door 29 is also operated to a fully closed position of the foot opening 27.

When the blower 44 of the blower unit 40 and a compressor of the refrigerant cycle are operated, air blown by the blower unit 40 is cooled in the evaporator 12. The cool air from the evaporator 12 flows into the face opening 26 through the cool air bypass passage 15, and the cool air from the face opening 26 is blown toward the upper body of the passenger in the passenger compartment from the face air outlet through the face duct.

When the air mixing door 16 is operated to the solid line position in FIG. 2 (the position 16a in FIG. 1), all cool air after passing through the evaporator 12 is introduced into the face opening 26 through the cool air bypass passage 15, and maximum cooling capacity can be obtained. Further, when the air mixing door 16 is rotated a position between the maximum cooling position (solid line position in FIG. 2) and the maximum heating position (chain line position in FIG. 2), the flow ratio between warm air passing through the heater core 13 and cool air passing through the cool air bypass passage 15 can be adjusted, and conditioned air having a desired temperature can be blown toward the upper body of the passenger in the passenger compartment.

(2) Bi-Level Mode

The bi-level mode is generally used in a middle season such as the spring and the autumn. When the bi-level mode is set, the defroster door 22, the face door 28 and the foot door 29 are operated to the positions shown in FIG. 3. At this time, the defroster door 22 is maintained at the position P1 in the face mode, so that the defroster opening 21 is fully closed similarly to the face mode.

In contrast, the face door 28 is operated at a middle position so as to open both the face opening 26 and the foot opening 27. At the same time, the foot door 29 is operated to a fully-opening position of the foot opening 27. As a result, in the bi-level mode, both the face opening 26 and the foot opening 27 communicate with the downstream side of the air mixing portion 20 in an approximate half-open state. As a result, conditioned air having a desired temperature adjusted by the air mixing door 16 is blown toward the upper and lower portions of the passenger in the passenger compartment from both the face opening 26 and the foot opening 27.

(3) Foot Mode

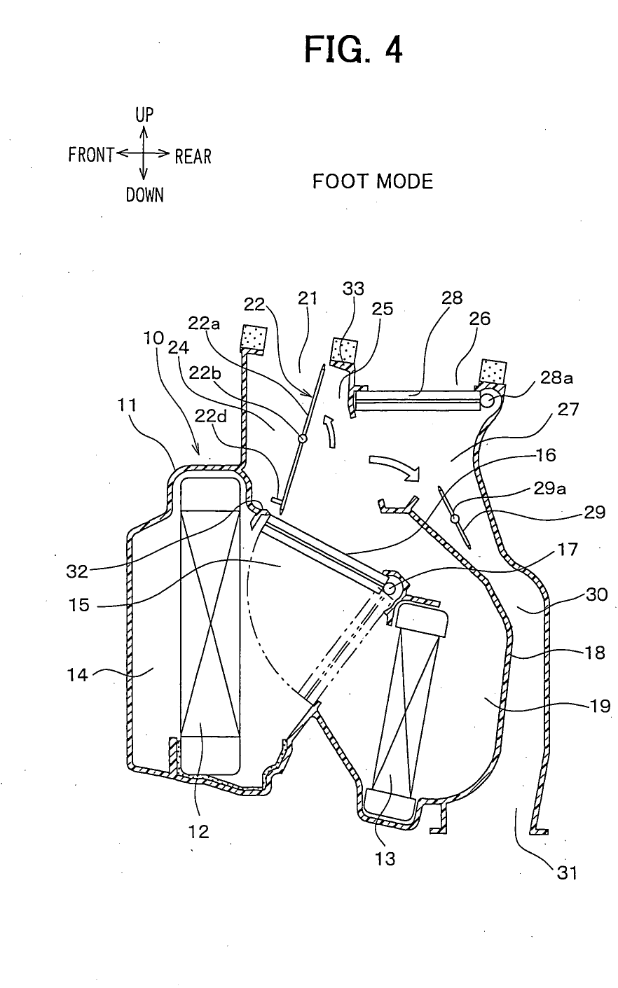

The foot mode is generally used in a heating operation in the winter. When the foot mode is set, the defroster door 22, the face door 28 and the foot door 29 are operated to the positions in FIG. 4, respectively. In the foot mode, the defroster door 22 is operated to be slightly separated from the ribs 32, 33. Therefore, the defroster door 22 slightly opens the first and second communication passages 24, 25 at the inlet side of the defroster opening 21. In contrast, the face door 28 fully closes the face opening 26, and the foot door 29 fully opens the foot opening 27.

Thus, a large amount of warm air heated in the heater core 13 is blown toward the foot area of the passenger in the passenger compartment, and a small amount (e.g., about 10-20%) of warm air is blown toward the inner surface of the windshield from the defroster opening 21.

Accordingly, in the foot mode, the foot area of the passenger in the passenger compartment can be heated while the windshield can be defrosted. When the air mixing door 16 is operated to the maximum heating position shown by the solid line in FIG. 4, all air after passing through the evaporator 12 flows into the air passage in the core portion 13 to be heated, so that a maximum heating capacity can be obtained.

(4) Foot/Defroster Mode (Foot/Def Mode)

Similarly to the foot mode, the foot/defroster mode is generally used in the heating operation in the winter. When the foot/defroster mode is set, the defroster door 22, the face door 28 and the foot door 29 are operated to the solid positions, respectively, in FIG. 1. When the foot/defroster mode is set, the defroster door 22 is rotated from the position of the foot mode shown in FIG. 4 by a predetermined angle in counterclockwise. Therefore, in the foot/defroster mode, the opening degree of the first and second communication passages 24, 25 at the inlet side of the defroster opening 21 is increased by a predetermined degree as compared with that in the foot mode. By contrast, in the foot/defroster mode, the face opening fully closes the face opening 26 and the foot door 29 fully opens the foot opening 27.

Accordingly, in the foot/defroster mode, conditioned warm air is blown toward the foot area of the passenger in the passenger compartment through the foot opening 27, and at the same time, the conditioned warm air is blown toward the inner surface of the windshield of the vehicle through the defroster opening 21. In the foot/defroster mode, because the opening degree of the defroster opening 21 is increased by the predetermined degree as compared with the foot mode, the air amount blown from the defroster opening 21 is increased as compared with the foot mode, and the defrosting performance of the vehicle windshield can be improved as compared with the foot mode.

(5) Defroster Mode (Def Mode)

The defroster mode is generally set temporarily for defrosting the windshield of the vehicle. When the defroster mode is set, the defroster door 22, the face door 28 and the foot door 29 are operated to the positions shown in FIG. 5 by the air-outlet mode operation mechanism. At this time, the defroster door 22 is operated to the fully-opening position (second position P2 in FIG. 1) of the defroster opening 21. That is, the defroster door 22 is slightly tilted to a vehicle front side from the vertical direction by a little angle. At this time, the plate surface of the defroster door 22 is approximately parallel to an air flow in each communication passage 24, 25, and air pressure loss in the defroster opening 22 becomes smallest.

By contrast, in the defroster mode, the face door 28 is operated to fully close the face opening 26, and the foot door 29 is operated to fully close the foot opening 27. Further, when the air mixing door 16 is operated to the maximum heating position as shown in FIG. 5, all air from the evaporator 12 is heated in the heater core 13, and the heated air is blown from the defroster opening 21 toward the inner surface of the windshield. Even in the defroster mode, the air mixing door 16 can be operated at a suitable position between the maximum cooling position and the maximum heating position. In this case, conditioned air having a desired temperature can be blown toward the inner surface of the windshield.

When the temperature of outside air is low such as in the winter, one of the foot mode and the foot defroster mode is set, and the heating operation of the passenger compartment is performed. At this time, the refrigerant cycle is operated for dehumidifying air to be blown into the passenger compartment. When air blown by the blower unit is cooled and dehumidified by the evaporator 12, condensed water is generated on the surface of the evaporator 12.

When the blower 44 and the compressor of the air conditioner are stopped in accordance with a stop of a vehicle engine in a state where the condensed water is generated on the surface of the evaporator 12, the condensed water is evaporated by heat of the heater core 13.

Generally, the hot water in the heater core 13 is maintained at a high temperature state for a time by its thermal capacity, even after the operation of the air conditioner is stopped. Therefore, air around the heater core 13 is heated for a time by the heater core 13 after the air conditioner is stopped. Furthermore, because the heater core 13 and the evaporator 12 are arranged by the-small distance L, a part of air heated by the heater core 13 is introduced toward an upper side in the air conditioning case 11 due to the natural convection.

The arrows A1, A2 and B in FIG. 1 show air-flowing states in the foot/defroster mode when the operation of the air conditioner is stopped. The arrow Al indicates hot air going toward the evaporator 12, the arrow B indicates hot air going toward the communication passage 25 after passing the warm air passage 13 upwardly. Further, the hot air shown by the arrow Al passes a narrow clearance between the top end portion of the air mixing door 16 and a downstream air surface of the evaporator 12 and flows to an upper side of the air mixing door 16 as shown by the arrow A2.

As described above, the hot air heated in the heater core 13 flows upwardly along the downstream wall surface of the evaporator 12, the evaporation of the condensed water on the evaporator 12 can be facilitated. As a result, hot air shown by the arrow A2 flowing to the upper side of the air mixing door 16 becomes a high-humidity air including water vapor due to the evaporation of the condensed water.

However, according to the first embodiment of the present invention, the guide member 22d is formed in the door body portion 22a to protrude into the first communication passage. 24 toward the evaporator 12 by the predetermined height “h” from the plate surface of the door body portion 22a of the defroster door 22 at a position proximate to the lower end portion of the door body portion 22a. Therefore, an opening area (opening degree) of the first communication passage 24 at the side of the evaporator 12 can be reduced to a very small value.

Because an air flow resistance is generated in the first communication passage 24 on the side of the evaporator 12 by the guide member 22d, the air flow resistance in the second communication passage 25 on the side opposite to the evaporator 12 is relatively small as compared with the air flow resistance in the first communication passage 24, among both the communication passages 24, 25.

Accordingly, an upward flow amount of hot air from the heater core 13 toward the downstream air side of the heater core 13 becomes larger, but an upward flow amount of hot air from the heater core 13 toward the upstream air side of the heater core 13 becomes smaller. Therefore, an evaporation amount of condensed water due to the upward flow amount of hot air from the heater core 13 can be effectively reduced. In addition, even when water vapor due to the evaporation of the condensed water flows to the upper surface side of the air mixing door 16, the guide member 22d can restrict the high-humidity air from being directly introduced into the first communication passage 24 at the side of the evaporator 12.

As a result, almost the high-humidity air having the water vapor due to the evaporation of the condensed water flows toward the second communication passage 25 as shown by the arrow A2. The hot air from the warm air passage 19 is dry air without including the water vapor due to the evaporation of the condensed water. Accordingly, even when a small amount of the high-humidity air shown by the arrow A2 is mixed with the dry air shown by the arrow B from the warm air passage 19, the humidity of the mixed air in the second communication passage 25 is not increased so much.

As described above, because the dry air from the warm air passage 19 flows through the second communication passage 25 on the side opposite to the evaporator 12, and flows into the defroster opening 21, as the main air to be introduced into the defroster opening 21. Because the hot air from the warm air passage 19 has a low humidity, the temperature of the hot air does not reach the dew point even when the hot air from the warm air passage 19 contacts the inner surface of the windshield. Therefore, a fogging is not caused on the windshield of the vehicle.

In the foot mode, because the passage opening area (opening degree) of the two communication passages 24, 25 is further reduced as compared with the foot/defroster mode, it can further restrict the windshield from being fogged after the operation of the air conditioner is stopped in the foot mode.

In the defroster mode shown in FIG. 5, the defroster door 22 is operated at the fully opening position of the defroster opening 21, and the passage opening area of the first communication passage 24 on the side of the evaporator 12 becomes larger even when the guide member 22d is provided. However, the defroster mode is a specific mode, and is temporality used for a short time in order to remove a fogging of the windshield immediately. Generally, the defroster mode is not continuously used for a long time. Therefore, the operation of the vehicle air conditioner is generally not stopped in the defroster mode. Accordingly, even when the passage opening area of the first communication passage 24 on the side of the evaporator 12 is set larger, the present invention can be effectively used.

### Second Embodiment

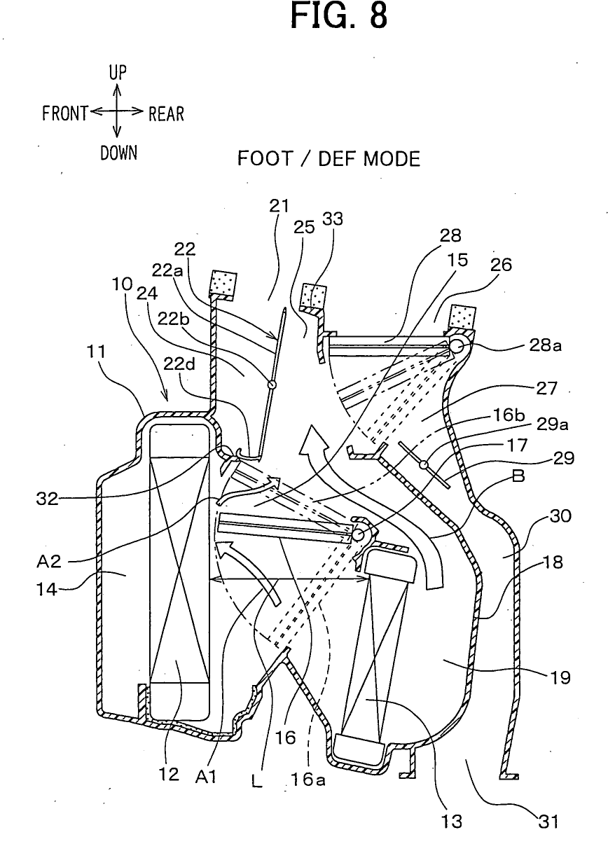

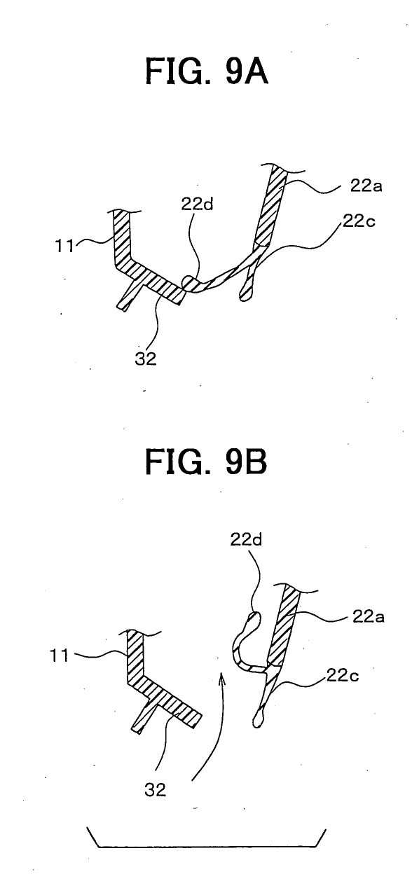

The second embodiment of the present invention will be now described with reference to FIGS. 8, 9A and 9B. In the above-described first embodiment of the present invention, the guide member 22 is formed integrally with the door body portion 22a of the defroster door 22, and the guide member 22d is constructed with the rigid body having the plate shape. In contrast, in the second embodiment, the guide member 22d is constructed with an elastic member having a plate shape.

As shown in FIGS. 8, 9A and 9B, a guide member 22d constructed with a plate-shaped elastic member is provided in the lower end portion of the door body portion 22a of the defroster door 22. For example, the guide member 22d can be made of the same material (e.g., thermoplastic elastomer) as the elastic seal portion 22c. In this case, the guide member 22d can be molded integrally with the elastic seal member 22c. The guide member 22d has a base portion connected to the elastic seal portion 22c (door body portion 22a) and a tip end portion. A plate thickness of the base portion of the guide member 22d in cross section is set smaller than a plate thickness of the tip end portion of the guide member 22d in cross section, so that the guide member 22d can be readily elastically deformed from the base portion of the guide member 22d in the up-down direction.

FIGS. 8 and 9A show a state in the foot/defroster mode after the operation of the air conditioner is stopped. In this operation stop state of the air conditioner, an air pressure applied to the guide member 22d from a lower side to an upper side is not generated due to the stop of the blower 44. Therefore, the tip end portion of the guide member 22d, having the larger thickness, falls downwardly due to its weight, and contacts the upper surface of the rib 32, as shown in FIG. 9A.

Accordingly, as shown in FIG. 8, the first communication passage 24 at the side of the evaporator 12 becomes substantially in a closed state, among the first and second communication passages 24, 25 at the inlet side of the defroster opening 21. Therefore, after the air conditioner is stopped, it can further restricted the high-humidity air due to the evaporation of the condensed water from flowing into the defroster opening 21. As a result, defogging performance of the windshield, after the operation of the air conditioner is stopped, can be further improved.

In contrast, FIG. 9B shows an operation state of the air conditioner. When the air conditioner is operated, because the air pressure is applied to the guide member 22d from the lower side to the upper side by the operation of the blower 44, the guide member 22d is pressed upwardly by the air pressure. Thus, when the air conditioner is operated, the passage opening area (opening degree) of the first communication passage 24 can be also sufficiently increased, the air amount blown from the defroster opening 21 can be increased.

### Third Embodiment

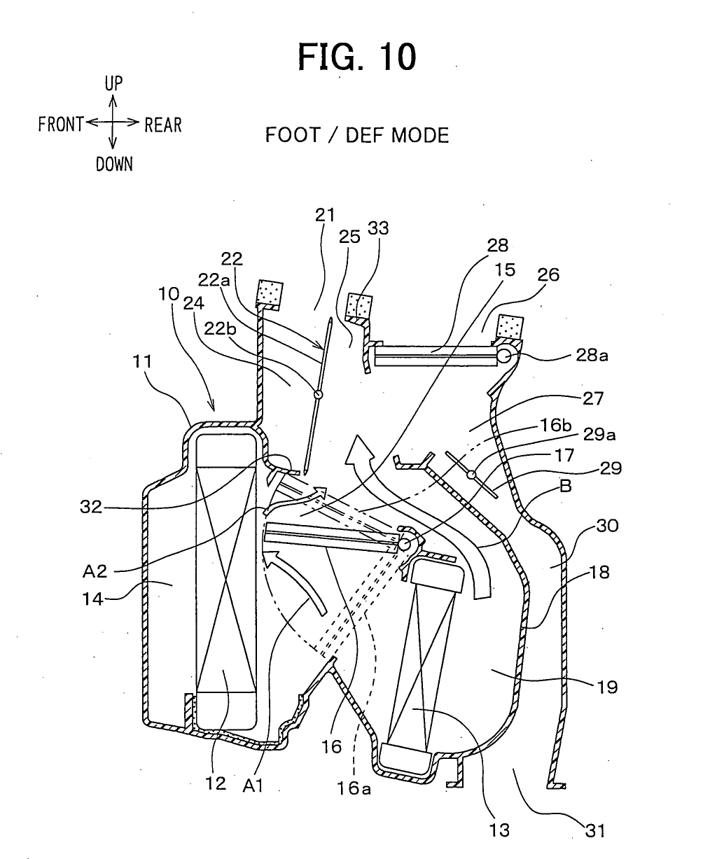

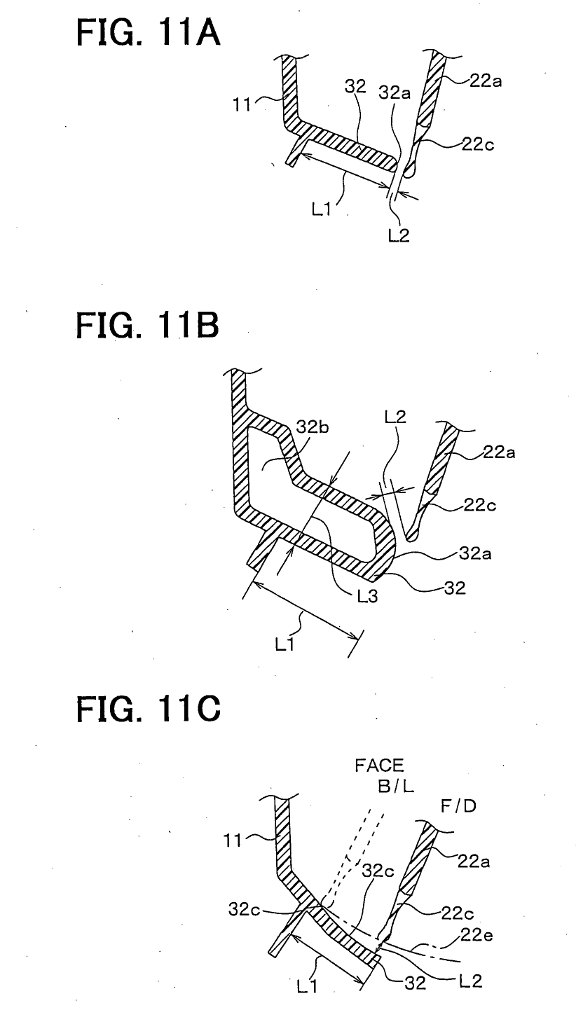

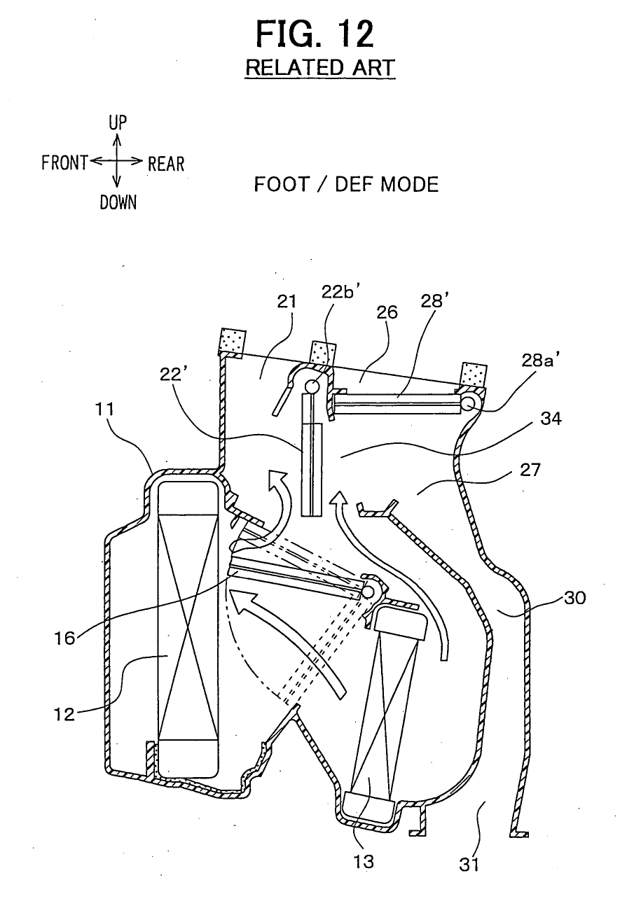

The third embodiment of the present invention will be now described with reference to FIGS. 10 and 11A-11C. In the above-described first and second embodiments of the present invention, the guide member 22d is provided in the door body portion 22a of the defroster door 22. However, in the third embodiment, the guide member 22d is not provided in the door body portion 22a, but the rib 32 formed in the air conditioning case 11 is used as a guide member (guide means) for defogging the windshield.

FIGS. 11A-11C show three examples of the rib 32 provided in the air conditioning case 11 according to the third embodiment. In this example shown in FIG. 11A, a protrusion dimension L1 of the rib 32 is set larger as compared with that in the first and second embodiments, so that a clearance L2 between a tip end portion of the rib 32 and the elastic seal portion 22c becomes equal to or smaller than 3 mm. In this case, even when the guide member 22d is not provided in the door body portion 22a, the defogging effect for defogging the windshield can be obtained similarly to the first embodiment. According to studies by the inventors of the present application, when the clearance L2 is set equal to or smaller than 3 mm, the defrosting effect of the windshield, while the air conditioner is stopped, can be obtained.

Further, as shown in FIG. 11A, a smooth circular arc portion 32a is formed at the top portion of the rib 32. Thus, when the defroster door 22 is operated from the position of the foot/defroster mode to the position of the bi-level mode or the face mode, the elastic seal portion 22c can be smoothly placed on the rib 32, and the door operation force can be reduced.

In the example shown in FIG. 11B, the rib 32 has a hollow portion 32b so as to enlarge a thickness dimension L3, so that the curvature radius of the circular arc portion 32a at the top end portion of the rib 32 is increased to a predetermined value equal to or larger than 5 mm. Further, when the defroster door 22 is operated to the operation position in the foot/defroster mode, the top end portion of the elastic seal portion 22c of the door body portion 22a is positioned to have the clearance L2 with the circular arc portion 32a of the rib 32. Here, the clearance L2 is set equal to or smaller than 3 mm.

In this case shown in FIG. 11B, when the defroster door 22 is operated from the position of the foot/defroster mode to the position of the bi-level mode or the face mode, the elastic seal portion 22c can be more smoothly placed on the rib 32, and the door operation force can be further reduced.

In the example shown in FIG. 11C, a recessed circular arc surface 32c is formed on an upper surface of the rib 32. The circular arc surface 32c is provided to be gradually separated from a rotation locus 22e of the top portion of the elastic seal portion 22c of the door body portion 22a as toward the top end side of the rib 32.

In the foot/defroster mode, the defroster door 22 is operated so that the top end portion of the elastic seal portion 22c of the door body portion 22a is positioned above the top end portion of the circular arc surface 32c on the rib 32 to form the clearance L2. In contrast, when the defroster door 22 is operated from the position of the foot/defroster mode to the position of the bi-level mode and the face mode, the elastic seal portion 22c of the door body portion 22a can be further smoothly placed on the circular arc surface 32c of the rib 32 as shown by the chain line position, and the door operation force can be more effectively reduced.

In the examples 11A, 11B and 11C of the third embodiment, in the foot/defroster mode, by setting the clearance L2 between the top end portion of the rib 32 and the elastic seal portion 22c of the door body portion 22a to be equal to or smaller than a predetermined value (e.g., 3 mm), the defogging effect for defogging the windshield can be effectively improved when the air conditioner is stopped.

In the above-described third embodiment, the rib 32 provided in the air conditioning case 11 is used as the guide member that restricts an air flowing amount passing through the first communication passage 24 when the air conditioner is stopped. Further, the three examples shown in FIGS. 11A-11C are indicated. However, the rib 32 used as the guide member can be formed into the other shape.

Although the present invention has been fully described in connection with the preferred embodiments thereof with reference to the accompanying drawings, it is to be noted that various changes and modifications will become apparent to those skilled in the art.

For example, in the above-described embodiments, the evaporator 12 and the heater core 13 are vertically disposed to be arranged adjacently. However, the present invention can be applied to a vehicle air conditioner where the evaporator 12 and the heater core 13 are not disposed approximately vertically. Only when the evaporator 12 and the heater core 13 are arranged adjacently to have a predetermined distance therebetween, the present invention can be effectively used. Further, the face door 28 and the defroster door 29 can be formed by the other type doors without being limited to that of the above-described embodiments.

Such changes and modifications are to be understood as being within the scope of the present invention as defined by the appended claims.

What is claimed is:

1. An air conditioner for a vehicle having a passenger compartment, the air conditioner comprising:
an air conditioning case for defining an air passage through which air flows into the passenger compartment, the air conditioning case having at least a defroster opening from which air is blown toward an inner surface of a windshield of the vehicle;
a cooling heat exchanger, disposed in the air conditioning case, for cooling air;
a heating heat exchanger for heating air, the heating heat exchanger being disposed in the air conditioning case downstream from the cooling heat exchanger to be separated from the cooling heat exchanger by a space smaller than a predetermined distance;
a defroster door for opening and closing the defroster opening, the defroster door being constructed with a butterfly door having a plate-shaped door body portion and a rotation shaft arranged at a center portion of the door body portion; and
a guide member disposed to restrict an air flow from a downstream side of the cooling heat exchanger into the defroster opening, wherein:
the defroster opening is provided at an upper side of the cooling heat exchanger and the heating heat exchanger, and is partitioned into a first communication passage on a side of the cooling heat exchanger and a second communication passage on a side opposite to the cooling heat exchanger by a plate surface of the door body portion when the defroster opening is opened by the defroster door;
the rotation shaft of the defroster door is rotatably held in the case; and
the guide member is provided in the first communication passage.

2. The air conditioner according to claim 1, wherein the air conditioning case further has a foot opening provided to communicate with a downstream side of the heating heat exchanger, the air conditioner further comprising
a foot door disposed to open and close the foot opening.

3. The air conditioner according to claim 1, wherein:
the door body portion has an upstream end portion and a downstream end portion in a flow direction of air passing through the defroster opening; and
the guide member is provided to protrude from the upstream end portion of the door body portion into the first communication passage.

4. The air conditioner according to claim 3, wherein the guide member is a rigid plate molded integrally with the door body portion.

5. The air conditioner according to claim 3, wherein the guide member is an elastic plate bonded to the door body portion.

6. The air conditioner according to claim 5, further comprising
a blower for blowing air in the air conditioning case, wherein:
when the blower is operated, the guide member is pressed to an upper side by an air pressure, and is elastically deformed to increase a passage sectional area of the first communication passage; and
when the blower is stopped, the guide member is elastically deformed by its weight to reduce the passage sectional area of the first communication passage.

7. The air conditioner according to claim 2, wherein:
the door body portion has an upstream end portion and a downstream end portion in a flow direction of air passing through the defroster opening;
the guide member is a rib protruding toward the upstream end portion of the door body portion from the air conditioning case at a position where the first communication passage is formed; and
the guide member is provided in such a manner that a clearance between the guide member and the upstream end portion of the door body portion is equal to or smaller than 3 mm when the defroster door is operated to an operation position of a foot/defroster mode where both the defroster opening and the foot opening are opened.

8. The air conditioner according to claim 1, wherein:
in the air conditioning case, air flows through the air passage from a vehicle front side to a vehicle rear side;
the cooling heat exchanger is provided at a vehicle front side of the heating heat exchanger;
the defroster opening is provided at an upper side of the space between the cooling heat exchanger and the heating heat exchanger;
the defroster door is arranged in the air conditioning case such that the rotation shaft extends in a vehicle right-left direction and the plate surface of the door body portion extends in a vehicle up-down direction;
the first communication passage is provided at a vehicle front side of the plate surface of the door body portion; and
the second communication passage is provided at a vehicle rear side of the plate surface of the door body portion.

9. The air conditioner according to claim 1, wherein each of the cooling heat exchanger and the heating heat exchanger is arranged approximately vertically.

10. The air conditioner according to claim 1, further comprising
an air mixing door, disposed between the cooling heat exchanger and the heating heat exchanger, for adjusting a flow ratio between an air amount passing through the heating heat exchanger and an air amount bypassing the heating heat exchanger,
wherein the air mixing door is a plate door rotatable in a vehicle up-down direction around a rotation shaft that is provided at an upper side of the heating heat exchanger.
